(19) United States
(12) Patent Application Publication
(10) Pub. No.: US 2014/0022033 A1
(43) Pub. Date: Jan. 23, 2014

(54) MINI HIGH-POWER MAGNETIC LATCHING RELAY

(71) Applicant: NINGBO FORWARD RELAY CORP. LTD, Ningbo (CN)

(72) Inventors: Xiaoxia Yang, Ningbo (CN); Quanwei Hu, Ningbo (CN); Shuijun Wang, Ningbo (CN)

(73) Assignee: NINGBO FORWARD RELAY CORP. LTD, Ningbo (CN)

(21) Appl. No.: 13/837,475

(22) Filed: Mar. 15, 2013

(30) Foreign Application Priority Data
Jul. 19, 2012 (CN) 201220350593.0

(51) Int. Cl. H01H 71/32

(52) U.S. Cl. CPC H01H 71/32
USPC 335/170

(57) ABSTRACT

The utility model discloses a mini high-power magnetic latching relay, comprising a magnetic circuit, a contact part and a thrust disk; the magnetic circuit comprises a coil former, a coil, a magnetic enclosure, an iron core and a yoke; the magnetic enclosure comprises an alnico and an armature, characterized in that the coil former comprises a hollowed cylindrical shaft, a 1st mounting base and a 2nd mounting base; the 1st and 2nd mounting bases are horizontally arranged and integrated on the end of the cylindrical shaft; the magnetic enclosure is mounted on the thrust disk as installed on the 1st mounting base for coordinated sliding; whereas the contact part is mounted inside the 2nd mounting base for connection with the thrust disk; the utility model is characterized in that the magnetic enclosure and the contact part are on the same end of the coil former, which can reserve more expansion space for the coil, and thus improve loading capacity of the magnetic latching relay. Furthermore, the whole relay featuring in compact structure and small volume is applicable to the printed circuit board requiring high power and small volume of relay, which can expand the application scope of magnetic latching relay.

### FIELD OF THE INVENTION

The utility model relates to a relay, in particular, to a mini high-power magnetic latching relay.

### BACKGROUND OF THE INVENTION

Accompanied by extensive applications, more relays of different functions and structures have come into being, wherein, electromagnetic relay and magnetic latching relay are the most common ones. Normally, higher load may result in increased volume no matter which type of relay is used. However, such relay of higher load and volume is not applicable to the printed circuit board compatible with the relay of high power and small volume which may result in restricted application of the relay.

### SUMMARY OF THE INVENTION

Technical issue to be settled by the utility mode is to provide a mini high-power magnetic latching relay of high load and small volume.

The utility model provides the following solution to solving aforesaid technical issue: A mini high-power magnetic latching relay, comprising a magnetic circuit, a contact part and a thrust disk, wherein the said magnetic circuit comprises a coil former, a coil, a magnetic enclosure and a yoke; the said magnetic enclosure comprises an alnico and a yoke; the said coil former comprises a hollowed cylindrical shaft, a 1st mounting base and a 2nd mounting base; the said 1st and 2nd mounting bases are horizontally arranged and integrated on the end of the said cylindrical shaft; the said magnetic enclosure is firmly mounted on the said thrust disk; the said thrust disk is mounted on the said 1st mounting disk for coordinated sliding; the said contact part is mounted inside the 2nd mounting base; the said thrust disk is connected with the said contact part.

The said coil is wrapped on the said cylindrical shaft; the said iron core penetrates the said cylindrical shaft for fixing to the rear end of the said yoke; the said yoke is provided with a U-shape front end oriented downwards to cover on the said magnetic enclosure; the said armature in two pieces is vertically arranged on both sides of the said magnetic enclosure; the said armature and alnico are in a U-shape; the end of the said iron core is between the two armatures; the said thrust disk is provided with a magnetic enclosure mounting hole; the end of the said armature is integrated with the said alnico for interference fit with the said magnetic enclosure mounting hole.

Two corners on the armature for matching with the magnetic enclosure mounting hole are chamfered to enable the armature and magnetic enclosure mounting hole to form a dispensing space so as to ensure firm coupling between magnetic enclosure and thrust disk.

The said mini high-power magnetic latching relay further comprises a hood and a base plate; the said base plate is arranged below the said coil former; whereas numerous support pins are integrated on the underside of the said coil former.

Height of the said support pin is 0.6-1.0 mm;

The said contact part comprises dynamic and static contact assemblies, wherein the said static contact assembly includes a static wafer and a static contact; the said static wafer is inserted inside the 2nd mounting base vertically to the base plate; the said dynamic contact assembly includes a dynamic wafer, a dynamic contact and a dynamic reed pin; front end of the said dynamic wafer is plugged into the said thrust disk with rear end riveted with the rear end of the said yoke; the said reed pin is riveted to the said yoke.

Contact interval is defined as 0.4 mm-0.6 mm and 1.8 mm-2.0 mm respectively to facilitate selection of specific interval for the relay as per practical load, and prevent contact arc as produced by overcurrent from burning the contact.

Upper and lower ends of the said 2nd mounting base are provided with a slot respectively for the said static wafer.

The said coil is covered with an insulating sleeve that is arranged below the said yoke to increase the dielectric voltage resistance between the contact and coil to 4000 VAC/50 Hz.

Upper and lower ends of the said 2nd mounting base are provided with a heat emission hole respectively.

Upper and lower ends of the said 1st mounting base are provided with a chine respectively; the said thrust disk is provided with a joint pin arranged in the said chute for coordinated sliding; the said upper and lower ends are provided with a mounting recess as connected with the chute to facilitate installation of the said thrust disk.

As compared with prior art, the utility model is characterized in that the magnetic enclosure and the contact part are on the same end of the coil former, which can reserve more expansion space for the coil, and thus increase the loading capacity of the magnetic latching relay; to 80 A/277 VAC; furthermore, the whole relay featuring in compact structure and small volume is applicable to the printed circuit board requiring high power and small volume of relay, which can expand the application scope of magnetic latching relay; moreover, numerous support pins integrated on the underside of the coil former can form an air circulation layer between the coil former and the base plate, which can significantly improve radiation performance, and extend the service life of the relay; in addition, as the dynamic reed pin is riveted to or in split arrangement with the yoke, it is favorable for saving of materials.

### DRAWINGS

FIG. 1 is the assembly diagram for the utility model without hood;

FIG. 2 is a sectional view of FIG. 1;

FIG. 3 is a breakdown drawing of FIG. 1;

FIG. 4 is a structural diagram showing the bottom structure of the coil former of the utility model.

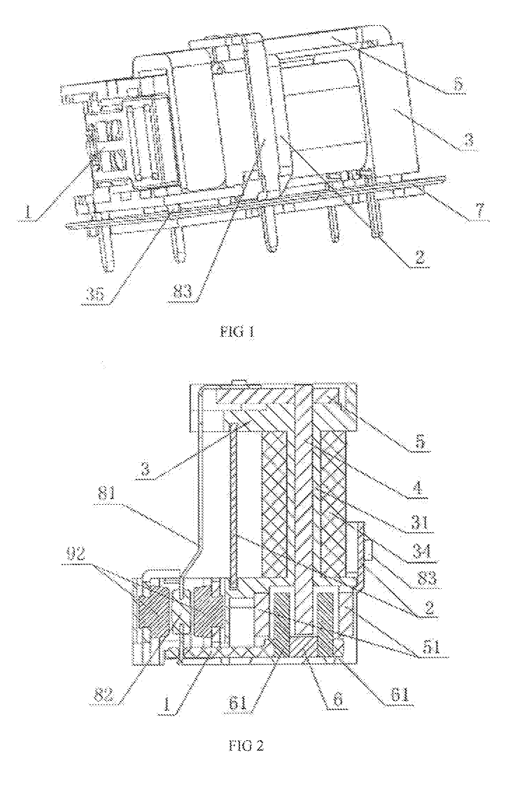

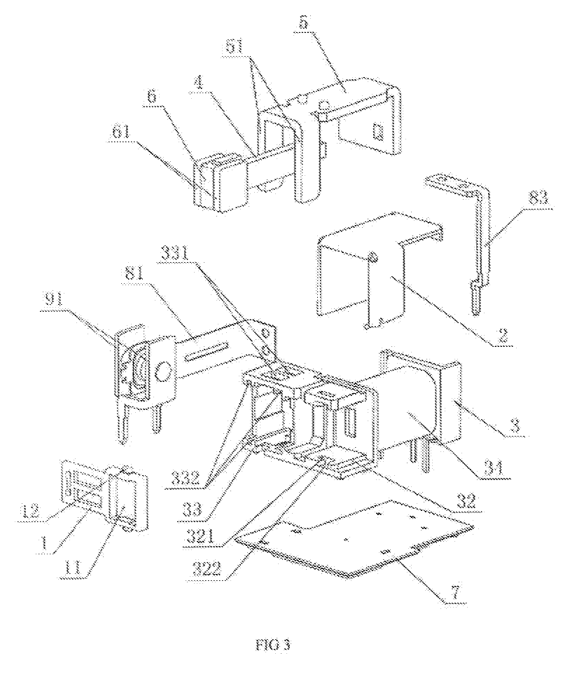

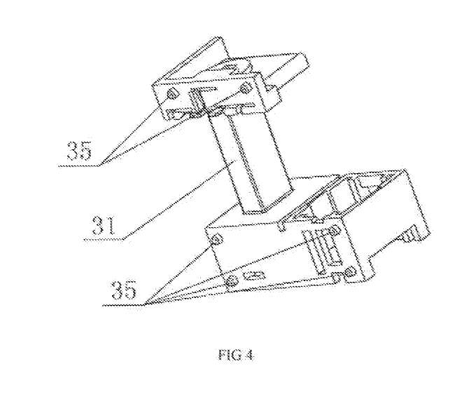

### DETAILED DESCRIPTION OF PREFERRED EMBODIMENTS

Detailed description of this utility model in combination with preferred embodiments is stated as follows:

A mini high-power magnetic latching relay as shown in drawings, comprising a magnetic circuit, a contact part, a thrust disk 1, an insulating sleeve 2, a hood (not illustrated) and a base plate 7, wherein the magnetic circuit includes a coil former 3, a coil 34, a magnetic enclosure, an iron core 4 and a yoke 5; the coil former 3 includes a hollowed cylindrical shaft 31, a 1st mounting base 32 and a 2nd mounting base 33; the 1st mounting base 32 and the 2nd mounting base 33 are horizontally integrated on the end of cylindrical shaft 31; the coil 34 is wrapped on the said cylindrical shaft 31; the insulating sleeve 2 covered on the coil 34 is arranged below the yoke 5; the iron core 4 penetrating through the cylindrical shaft 31 is fixed to the rear end of the yoke 5; front end of the yoke 5 is a U-shape end 51 covered on the magnetic enclosure with the opening oriented downwards; the magnetic enclosure comprises a alnico 6 and a armature 61 vertically arranged on both sides of it respectively; the armature 61 and the alnico 6 are in U-shape; the end of iron core 4 is arranged between two armatures 61; the thrust disk 1 is provided with a magnetic enclosure mounting hole 11; the end of armature 61 as integrated with the alnico 6 is in interference fit with the magnetic enclosure mounting hole 11; two corners on the armature 61 matching with the magnetic enclosure mounting hole 11 are chamfered; upper and lower ends of the 1st mounting base 32 are provided with a chute 321 respectively; the thrust disk 1 is provided with a joint pin 12 as arranged in the chute 321 for coordinated sliding; the said upper and lower ends are provided with a mounting recess 322 as connected with the chute 321 to facilitate installation of the said thrust disk 3; the contact part comprises a dynamic contact assembly and a static contact assembly; static contact assembly includes a static wafer 91 and a static contact 92; upper and lower ends of the 2nd mounting base 33 are provided with a chute 332; static wafer 91 is inserted into the slot 332 vertically to the base plate 7; the dynamic contact assembly includes a dynamic wafer 81, a dynamic contact 82 and a dynamic reed pin 83; the interval between dynamic contact 82 and static contact 83 is 2.0 mm at non-work status; front end of dynamic wafer 81 is inserted into the thrust disk 1 with rear end riveted to the rear end of the yoke 5; dynamic reed pin 83 is riveted to the yoke 5; upper and lower ends of the 2nd mounting base 33 are provided with heat emission hole 331; the base plate 7 is arranged below the coil former 3 with underside integrated with numerous support pins 35.

In the aforesaid preferred embodiments, contact interval can be selected within the range of 0.4 mm-0.6 mm and 1.8 mm-2.0 mm respectively as per practical load on the relay; height of support pin 35 can be selected within the range of 0.6 mm-1.0 mm as per practical demands.

1. A mini high-power magnetic latching relay, comprising a magnetic circuit, a contact part and a thrust disk, wherein the said magnetic circuit comprises a coil former, a coil, a magnetic enclosure and a yoke; the said magnetic enclosure comprises an alnico and a yoke, characterized in that the said coil former comprises a hollowed cylindrical shaft, a 1st mounting base and a 2nd mounting base; the said 1st and 2nd mounting bases are horizontally arranged and integrated on the end of the said cylindrical shaft; the said magnetic enclosure is firmly mounted on the said thrust disk; the said thrust disk is mounted on the said 1st mounting disk for coordinated sliding; the said contact part is mounted inside the 2nd mounting base; the said thrust disk is connected with the said contact part.

2. The mini high-power magnetic latching relay according to claim 1, characterized in that the said coil is wrapped on the said cylindrical shaft; the said iron core penetrates the said cylindrical shaft for fixing to the rear end of the said yoke; the said yoke is provided with a U-shape front end oriented downwards to cover on the said magnetic enclosure; the said armature in two pieces is vertically arranged on both sides of the said magnetic enclosure; the said armature and alnico are in U-shape together; the end of the said iron core is between the two armatures; the said thrust disk is provided with a magnetic enclosure mounting hole; the end of the said armature is integrated with the said alnico for interference fit with the said magnetic enclosure mounting hole.

3. The mini high-power magnetic latching relay according to claim 2, characterized in that two corners on the armature for matching with the magnetic enclosure mounting hole are chamfered.

4. The mini high-power magnetic latching relay according to claim 1, characterized in that it comprises a hood and a base plate, wherein the said base plate is below the said coil former, and numerous support pins are integrated on the underside of the said coil former.

5. The mini high-power magnetic latching relay according to claim 4, characterized in that the said contact part comprises dynamic and static contact assemblies, wherein the said static contact assembly includes a static wafer and a static contact; the said static wafer is inserted inside the 2nd mounting base vertically to the base plate; the said dynamic contact assembly includes a dynamic wafer, a dynamic contact and a dynamic reed pin; front end of the said dynamic wafer is plugged into the said thrust disk with rear end riveted with the rear end of the said yoke; the said reed pin is riveted to the said yoke.

6. The mini high-power magnetic latching relay according to claim 5, characterized in that the interval between each contact is 0.4-0.6 mm and 1.8-2.0 mm respectively.

7. The mini magnetic high-power magnetic latching relay according to claim 5, characterized in that upper and lower ends of the said 2nd mounting base are provided with slots for the said static wafer respectively.

8. The mini high-power magnetic latching relay according to claim 1, characterized in that an insulating sleeve is covered on the coil, which is arranged below the yoke.

9. The mini high-power magnetic latching relay according to claim 1, characterized in that upper and lower ends of the said 2nd mounting base are provided with a heat emission hole respectively.

10. The mini high-power magnetic latching relay according to claim 1, characterized in that upper and lower ends of the said mounting base are provided with a chute respectively; the said thrust disk is provided with a joint pin that is arranged inside the said chute for coordinated sliding; the said upper and lower ends are provided with a mounting recess as connected with the chute to facilitate installation of the said thrust disk.
